(19) United States
(12) Patent Application Publication
(10) Pub. No.: US 2006/0207007 A1
(43) Pub. Date: Sep. 21, 2006

(54) Portable bidet

(76) Inventor: Jeffrey B. Fogel, Long Beach, NY (US)

Correspondence Address: DILWORTH & BARRESE, LLP, 333 EARLE OVINGTON BLVD., UNIONDALE, NY, 11553, US

(21) Appl. No.: 11/435,513

(22) Filed: May 17, 2006

Related U.S. Application Data
(63) Continuation-in-part of application No. 10/808,755, filed on Mar. 25, 2004.

(51) Int. Cl. A47K 3/26; A47K 3/022; A61H 35/00

(52) U.S. Cl. 4/443

(57) ABSTRACT

A portable bidet configured having a convertible structure with a larger overall size during its use and a compact, smaller size during storing.

Priority is claimed to U.S. patent application Ser. No. 10/808,755, which was filed with the U.S. Patent and Trademark Office on Mar. 25, 2004, the contents of which are incorporated herein by reference.

### BACKGROUND OF THE INVENTION

1. Field of the Invention

The present invention relates generally to an apparatus for cleansing body parts, and more particularly to a portable bidet configured for convenient spraying of cleansing, rinsing and/or medicinal fluids onto appropriate and often discrete body surfaces.

2. Description of the Related Art

The nature of the human excretory process presents a fundamental situation associated with cleansing body surfaces of waste material. While many people utilize toilet tissue to deal with the situation, this practice can be abrasive, especially for hemorrhoid suffers, persons preparing to undergo a colonoscopy, females recovering from an episiotomy and other birth-related trauma and women during their menstrual cycle. Further, physically impaired persons may have difficulty utilizing toilet tissue for this purpose without substantial assistance from another individual. Many individuals able to perform the cleansing function with toilet tissue may elect not to for reasons such as personal hygiene, personal preference or recovery from a medical procedure.

For an incapacitated individual such as a paraplegic or quadriplegic, the cleansing of private body parts may be difficult if not impossible. Such incapacitation is not confined to specific age groups and, thus, even a person in the prime of his life may require assistance from another person to accomplish these simple but extremely private functions. As a result, emotional and psychological struggles are commonly encountered by such incapacitated persons. Such cleansing and flushing tasks are extremely personal and can be embarrassing, to say the least, to persons reliant upon others to perform such tasks. The portability of the present invention allows for greater privacy and ease of use.

Therefore, even for a fully capacitated individual, as the natural excretory process are usually performed while seated on a toilet, cleansing of an individual's groin/crotch area is a desirable function, particularly after the individual has utilized the toilet for defecation. Conventional methods for achieving this function include use of toilet tissue and the utilization a variety of apparatuses. Such conventional apparatuses, as explained below, fail to offer a discrete, hygienic, portable and cost effect device.

An alternative to toilet tissue is to spray liquid onto the various body parts, as done when using a bidet. Bidets, however, are stationary devices that have a fixed nozzle, thereby leaving the user with limited control over the application of cleansing water which, given sufficient pressure, can spray out onto the user's legs. Further, bidets typically locate the nozzle below the seat thereof, thereby requiring reaching down into the bowl to adjust the spray. Further still, the user cannot utilize a bidet to spray medicinal fluids or non-medicinal, soothing fluids.

Stationary, non-portable bidets are often elaborately configured and expensive. In addition, the multiple parts, such as nozzle heads, can be subject to mildew and mold, which readily grow in the moist environment, necessitating frequent cleaning. Another reason often voiced against the use of the stationary bidet is that such a bidet occupies the extra space and is cost-prohibitive. Accordingly, few bathrooms are equipped with a bidet. Further, such bidets, like toilets, are typically provided only with a supply of cold water, requiring sophisticated plumbing to achieve a spray of suitable temperature.

The need for a relatively simple, cost-effective cleansing device has led to numerous types of self-contained hand-held devices, such as U.S. Pat. No. 4,890,340 to Lovitt. As convenient as such devices may be, their relative large size makes such devices difficult to use. Overall, conventional hand-held bidets are cumbersome and difficult to discretely store. Accordingly, hand-held bidets thus far have remained relatively unpopular.

Thus, an object of the present invention is to provide a portable bidet characterized by a simple, easily maintained structure capable of applying warm, or other desired temperature, water, medicinal fluid or non-medicinal soothing fluid to the desired body parts of the user.

A further object of the invention is to allow these cleansing liquids to achieve room temperature prior to spray application.

A still further object of the invention is to provide a portable bidet with a safe, sanitary and self-contained nozzle for applying body treatments, that the user can set to a spray, mist or stream delivery, as appropriate for the desired cleansing function.

A further object of the invention is to provide a device that can be utilized in a comfortable, seated position that a user has already assumed during the excretory process.

Another object of the invention is to provide a portable bidet having greater accessibility to the general population due to its relatively small size and cost-efficiency.

A still further object of invention is to provide a portable bidet having a structure convenient in use without appearing obtrusive, which the user can discretely carry into and use in any available toilet.

### SUMMARY OF THE INVENTION

The inventive portable bidet is easily convertible between a storage position and an operative ready-to-use position, and then back to the storage position, to accomplish the above and other objects of the present invention. According to the invention, the portable bidet is configured with a reservoir preferably constructed from reinforced resilient material and having a self-contained, sanitary mechanism to facilitate use when inverted, i.e. turned to an upside-down position.

In accordance with one aspect of the invention, the portable bidet has a unique, reversible screw-top traversed by a hollow tube and capable of closing the reservoir with a larger portion of the hollow tube extending within the reservoir in the storage position of the bidet. Reversing the position of the screw-top (herein referred to as a reversible cap) and engaging the top of the reservoir so that the larger portion of the hollow tube extends outwards from the reservoir to define the operative position of the portable bidet, allowing the bidet to be utilized in accordance with the intended use.

When filled with lukewarm water or cleansing fluid (medicinal or non-medicinal) and closed with the screw-top, the inventive portable bidet is held by the user, conveniently positioned partially beneath the toilet seat, with the larger portion of the tube positioned under the front of the user's crotch/groin area. Of course, the user may alternatively fill the inventive bidet with water or other fluid, e.g. medicinal fluid, of any desired temperature, which can be done in a discrete fashion. The bidet may also be pre-filled with a preferred fluid. The compact size of the inventive device allows for the filling outside of the toilet, which is particularly useful when the fluid contains medication for topical application or when a public toilet must be utilized.

The inventive bidet is thus advantageous in many respects including, but not limited, providing a unique use of a portable convertible structure that is easy to use and store. The inventive bidet is portable, thereby allowing the user to carry the invention wherever desired and discretely perform a non-abrasive cleansing function regardless of configuration of the available toilet or sanitary facilities.

The inventive bidet provides a safe, efficient and sanitary device for applying warm, or other desired temperature, water delivery via a nozzle head configured to preclude insertion, reducing the possibility of injury and thus reducing liability inherent in our litigious society. The inventive bidet is cost-efficient and easily maintained, allowing the user to conveniently cleanse themselves in a discrete manner, without discomfort or abrasion.

### BRIEF DESCRIPTION OF THE DRAWINGS

The above and other objects, features and advantages will become more readily apparent from the detailed description of the invention accompanied by the following drawings, in which:

FIG. 1 is a view of the inventive portable bidet in a packaged or storing position;

FIG. 2 is an exploded view of a portion of the inventive portable bidet of FIG. 1;

FIG. 3 is a view of the inventive portable bide in an operative or ready-to-use position;

FIG. 4 is a view of a preferred use of the portable bidet;

FIG. 5 is an exploded view of a preferred use of the portable bidet;

FIG. 6 is a side view of a safety nozzle of the portable bidet; and

FIGS. 7a and 7b are views of alternative embodiments of the safety nozzle, with nozzle umbrella.

### DETAILED DESCRIPTION OF THE PREFERRED EMBODIMENTS

In the drawings, the same or similar elements are denoted by the same reference numerals. In the following description, a detailed description of known functions and configurations incorporated herein will be omitted to avoid obscuring the subject matter of the present invention with unnecessary detail.

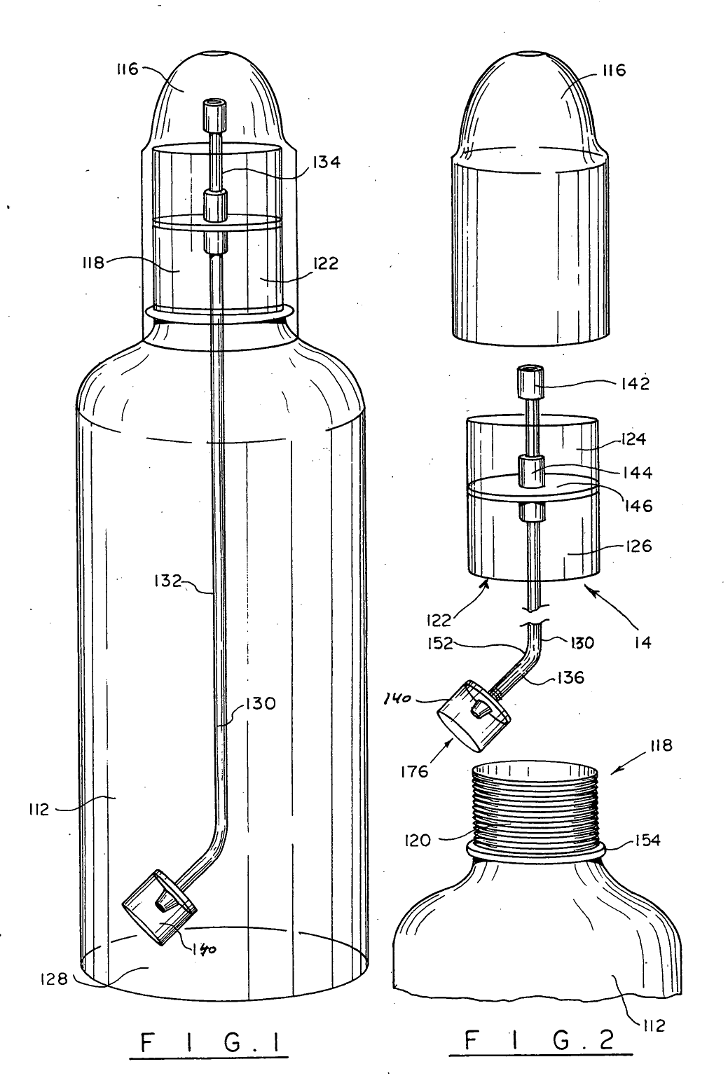

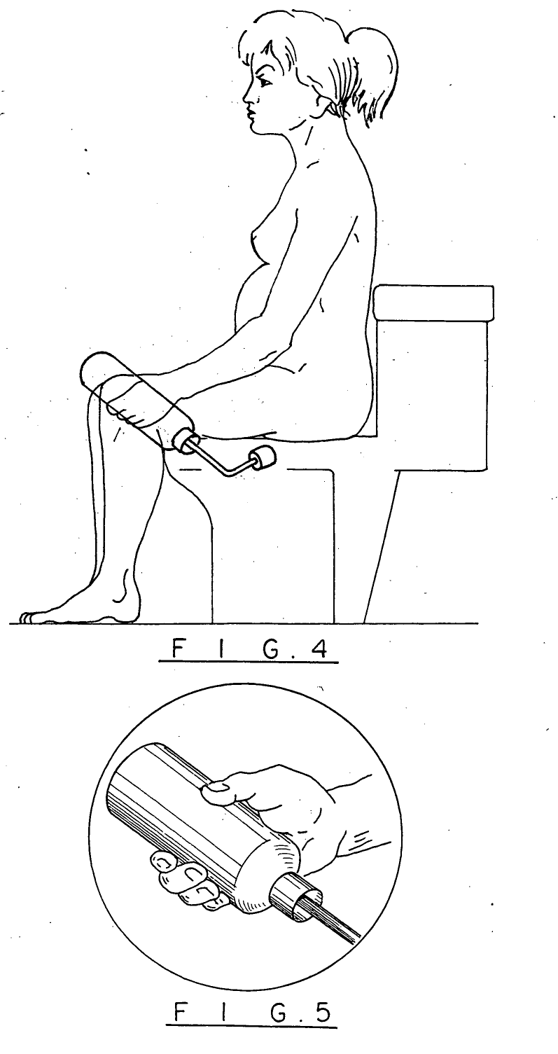

The inventive portable bidet illustrated in FIGS. 1-7 includes a convertible structure that allows the user to minimize the bidet's overall size while the latter is stored, as shown in FIG. 1, and readily converts the bidet to an operative position, as shown in FIGS. 3-5.

The portable bidet includes a reservoir 112 that is preferably sized to fit in a woman's purse and conveniently stored in a bathroom vanity, a fluid-delivering unit that is removably attachable to the reservoir 112 and a lid 116 covering the bidet in its storing position, as illustrated in FIG. 1. Convertibility of the bidet is realized by displacing the fluid-delivering assembly relative to the reservoir 112. Preferably, displacement is achieved by a reversible cap 122, described in greater detail below. Thus, in the storing position (FIG. 1), the fluid-delivering unit is coupled to the reservoir 112 so that a distal end thereof extends at a relatively small distance from the reservoir's top 118, whereas in the operative ready-to-use position (FIG. 3), a distal end thereof the fluid-delivering unit projects at a relatively large distance.

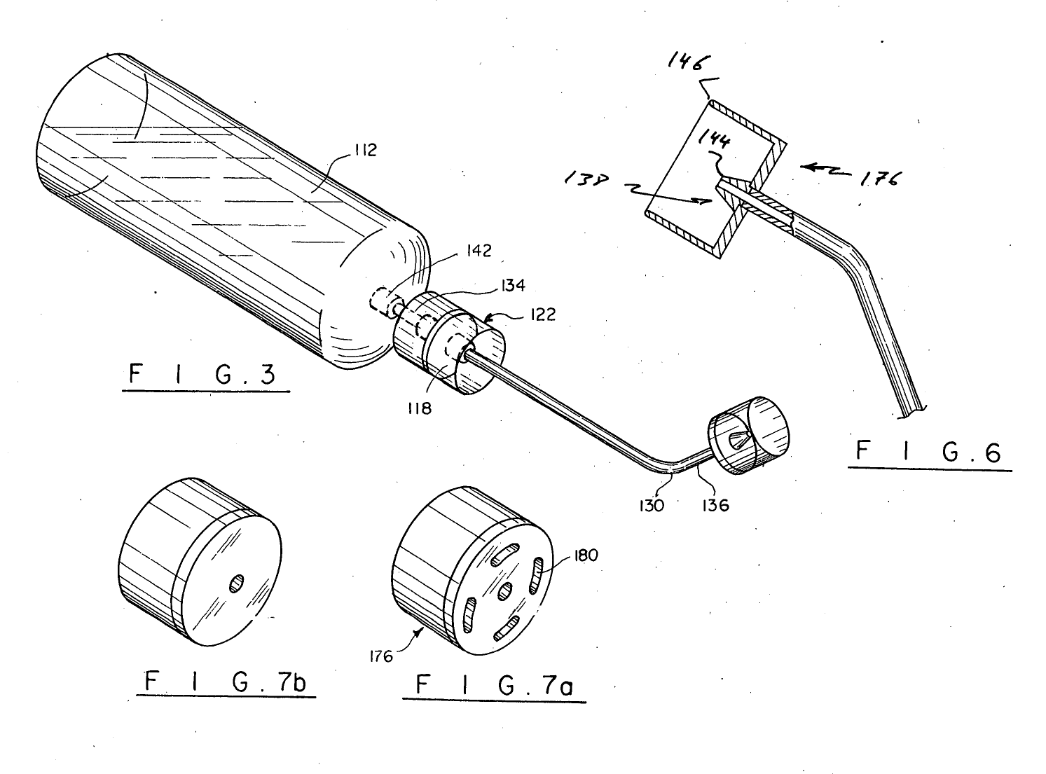

In contrast to conventional devices, storing the longer portion 132 of the tube 130 of fluid delivering assembly fully within the reservoir 112 allows for a higher level of hygiene. Although the fluid in the reservoir 112 is preferably replaceable by the user and the reservoir 112 can be filled with warm water, a benefit of the inventive bidet is to maintain its nozzle 138 (FIG. 6) applicator within a sanitizing fluid, e.g. Tucks®, or PreparationH®, Hazlets® Liquid, etc., which will be utilized for the cleansing function commonly performed with toilet tissue. It is readily appreciated that utilization of a sanitizing dispensed fluid in lieu of the wiping motion of toilet tissue will reduce irritation.

The reservoir 112 is preferably molded from rubber or a reinforced plastic material, and can alternatively be formed of a thin metal or other material that is resiliently yielding to an external squeezing force. Regardless of the shape of the reservoir 112, the top 118 thereof is preferably provided with outside screw-on threads 120 (FIG. 2) for engaging inside screw-on threads of the reversible cap 122 of the fluid-delivering unit. The reversible cap 122 is formed with screw-on threads formed on each of first and second opposite ends thereof 124, 126 (FIG. 2), for reversibility of the cap by the user. The external thread 120 of the top 118 is of corresponding size to the internal thread of the first and second ends 124, 126 of reversible cap 122.

The fluid-delivering unit includes hollow tube 130 (FIGS. 1-3) traversing the reversible cap 122 and fixed thereto with a longer portion 132 projecting well beyond the reservoir 112 when the bidet is the bidet is in the operative position. The longer portion 132 of tube 130 is preferably provided with a discharge end 136 (FIG. 2), preferably angled between 105° and 135° to facilitate delivery of the fluid from the reservoir 112 onto the desired body part without splash-back or the need to awkwardly position the bidet. Mounted on the end area 136 of the tube 130 is a nozzle 138 (FIGS. 1-3), preferably configured as a safety nozzle having a nozzle umbrella.

The safety nozzle is configured to preclude insertion into any bodily orifice during the cleansing function, by providing a surround structure 176 (FIGS. 7a and 7b) including an outer wall of a height that preferably extends beyond a distal end 144 of nozzle 138, forming the nozzle umbrella. The surround structure 176 has a width of approximately one inch, which along with an approximately ½ inch extension of a distal end 146 of the nozzle umbrella beyond the distal end 144 of the nozzle, eliminates undesired drippage back from the user's body part onto the nozzle, avoiding contamination thereof and facilitating reuse of the apparatus.

Maximum sanitary standards are provided by a combination of the above-described drip-back avoidance as well as the preferred 105° to 135° angle of the discharge end, as shown in FIG. 6. When the inventive device is considered in its entirety, it will be appreciated that the 105° to 135° angle allows for convenient use by positioning the bidet between the user's legs while seated on a toilet, as shown in FIG. 4, allowing for cleansing of both rectal and vaginal areas without having to place the reservoir 112 beneath the toilet rim. The preferred angle and configuration reduces fluid rebound that can contaminate the nozzle 138 or tube 130.

As shown in FIG. 7a, the surround structure 176 of the nozzle may be provided with drainage slots 180 to facilitate cleaning and to void any fluid accumulation. Nozzle 138 is preferably configured to provide a spray, stream or mist for varied intensity fluid delivery, to facilitate the various cleansing functions. It will be recognized that a spray delivery is preferable for cleansing of an episomotomy, while a stream delivery is preferable for cleansing the anal region. The end 142 of the shorter portion 134 of hollow tube 130 is preferably fitted with a mesh-type filter.

The removable lid 116 (FIG. 2) covers the shorter portion 124 of tube 130 when the portable bidet is in the storage position. Preferably, the lid 116 is snap-fitted onto a rim 154 of the reservoir 112. Alternatively, however, the reversible cap 122 or reservoir 112 is provided with external threads for engaging an inner thread provided on the lid 116.

In a preferred mode of operation, the bidet is operated by removing the lid 116, unscrewing first end 126 of reversible cap 122 of the fluid-delivering unit and extracting the longer end 132 and nozzle 138 from the reservoir 112. The orientation of the reversible cap 122 is then reversed, allowing the user to insert the shorter portion 134 of tube 130 into reservoir 112, and to seal the reservoir 112 by screwing second opposite end 124 of reversible cap 122. The fluid within the reservoir 112 can then be ejected from nozzle 138 via the longer portion 132 of the tube 130 that now projects from reservoir 112.

As shown in FIGS. 4 and 5, cleansing the desired body part can be fulfilled by squeezing the reservoir 12. Although the inventive assembly is shown as a bidet, its use is not limited exclusively to cleansing the rectal or vaginal areas and can be utilized to clean other body parts.

Although the preferred embodiments of the present invention have been disclosed for illustrative purposes, those skilled in the art will appreciate that various modifications of the shape and dimensions of the disclosed structure, including additions and substitutions, are possible without departing from the scope and spirit of the invention, which is defined by the accompanying claims.

What is claimed is:

1. A portable apparatus for performing a cleansing function of a body part, comprising:
a fluid delivering unit having a reservoir;
a reversible cap having a first end oppositely positioned with a second end; and
a hollow tube having longer and shorter portions extending from respective second and first opposite ends of the reversible cap,
wherein the hollow tube traverses the reversible cap creating a pathway for egress of fluid from the reservoir.

2. The portable apparatus of claim 1, further comprising:
a nozzle attached to a distal end of the longer portion of the tube.

3. The portable apparatus of claim 2, wherein the nozzle is contained within the reservoir when the apparatus is in a storage position.

4. The portable apparatus of claim 2, wherein the nozzle is a safety nozzle that further comprises:
a surround structure extending beyond a spray tip of the nozzle, and the surround structure encompasses the spray tip.

5. The portable apparatus of claim 4 wherein the safety nozzle includes drainage slots positioned adjacent to the distal end of the longer portion of the hollow tube.

6. The portable apparatus of claim 2 wherein the nozzle is adjustable to provide a stream of varying intensity.

7. The portable apparatus of claim 3, wherein the shorter portion of hollow tube is positioned within the reservoir and the longer portion of the hollow tube is positioned outside of the reservoir when the apparatus is in an operative position.

8. The portable apparatus of claim 3, further comprising:
a lid for covering the shorter portion of the hollow tube when the apparatus is in the storage position.

9. The portable apparatus of claim 8 wherein the lid snap fits onto the reservoir, covering the reversible cap and shorter portion of the hollow tube, when the apparatus is in a storage position.

10. The portable apparatus of claim 1, wherein the reservoir is filled with medicinal fluid.

11. The portable apparatus of claim 1, wherein the reservoir is filled with non-medicinal fluid.

12. The portable apparatus of claim 1, wherein the longer portion of the hollow tube includes a bend of 105° to 135° to facilitate application of the fluid onto the body part when a user is in a seated position and to reduce fluid rebound.

13. The portable apparatus of claim 9, wherein the lid prevents an undesirable fluid leak.

14. The portable apparatus of claim 1, wherein the reversible cap includes similarly sized screw threads on an interior of the first and second opposite ends, and the reservoir has corresponding screw threads on an exterior thereof for alternatively engaging the screw threads of the first and second opposite ends of the reversible cap.

15. A method of non-abrasively cleaning a body part, the method comprising:
transferring a portable apparatus having a reservoir from a storage position to an operative position by unscrewing a reversible cap having a hollow tube traversing the reversible cap, wherein
when in the storage position, a longer portion of the hollow tube extends into the reservoir with a nozzle attached to a distal end of the longer portion of the hollow tube and a shorter portion of the hollow tube is positioned outside of the reservoir, and
when in the operative position, the longer portion of the hollow tube is positioned outside of the reservoir and the shorter portion of the hollow tube is positioned within the reservoir; and
squeezing the reservoir causes ejection of fluid, via the hollow tube, from the reservoir and onto the body part.

16. The method of claim 15, further comprising:
precluding insertion of the nozzle into a bodily orifice by providing a surround structure that extends beyond and encircles the nozzle.
